(19) United States
(12) Patent Application Publication
(10) Pub. No.: US 2010/0152374 A1
(43) Pub. Date: Jun. 17, 2010

(54) FLAME-RETARDANT WATERBORNE POLYURETHANE DISPERSION

(75) Inventors: Leng-Long Jou, Sanchong City (TW); Ruei-Shin Chen, Changhua City (TW); Yuung-Ching Sheen, Jhubei City (TW); Yih-Her Chang, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/471,601

(22) Filed: May 26, 2009

(30) Foreign Application Priority Data
Dec. 12, 2008 (TW) 097148467

(51) Int. Cl. C08L 75/04

(52) U.S. Cl. 524/590; 525/453; 525/460; 525/450; 525/459

(57) ABSTRACT

The invention provides a flame-retardant waterborne polyurethane dispersion. The dispersion includes: 1 to 15 parts by weight of a phosphorus flame retardant containing active hydrogen; 10 to 40 parts by weight of a diisocyanate; 30 to 80 parts by weight of a polyol; and 1 to 15 parts by weight of an active hydrogen-containing compound, which is capable of forming a hydrophilic group.

### CROSS REFERENCE TO RELATED APPLICATIONS

This Application claims priority of Taiwan Patent Application No. 097148467, filed on Dec. 12, 2008, the entirety of which is incorporated by reference herein.

### BACKGROUND OF THE INVENTION

1. Field of the Invention

The present invention relates to a waterborne polyurethane, and in particular relates to a flame-retardant waterborne polyurethane.

2. Description of the Related Art

Polyurethane (PU) is applied in coatings, adhesives, or sealants, etc., due to its physical properties. Conventionally, solvent-based PUs were mainly used. However, because solvent-based PUs emit toxics, waterborne PUs have been developed.

Initially, conventional PUs had poor flame-retarded properties, and thus easily ignited. As such, flame-retardant waterborne PUs have been disclosed, wherein flame retardant compounds (e.g. a halogen compound, phosphorus compound or inorganic powder) are integrated into waterborne PUs.

Japanese Patent JP 2002235027 provides a flame retardant PU by integrating an inorganic flame-retardant into PU. Japanese Patent JP 2002294018 provides a core-shell star-shaped polymer. The core is the structure of the PU, and the shell is the structure of the acrylic acid. A flame-retarded property is produced by integrating a large amount of red phosphorous and inorganic flame retardants into the core-shell polymer. Taiwan Patent TW 261594 provides a flame retardant waterborne PU, wherein the nanoclay modified with a surfactant containing bromine is used as a flame retardant. Additionally, the flame retardant waterborne PU is fabricated by polymerization of the PU and the nanoclay.

Because the above flame retardants are usually fabricated by integrating flame retardant into PU, simply washing the above PU with water, will reduce the flame retardant effect. Although the problem can be resolved by increasing the amount of flame retardant used, other coating and processing difficulties arise.

Accordingly, there is a need to develop a flame-retardant waterborne PU that will be less affected by washing by water, without increasing coating and processing difficulties

### BRIEF SUMMARY OF THE INVENTION

The invention provides a flame-retardant waterborne polyurethane dispersion, comprising: 1 to 50 parts by weight of a phosphorus flame retardant containing active hydrogen; 10 to 40 parts by weight of a diisocyanate; 30 to 80 parts by weight of a polyol; and 1 to 15 parts by weight of an active hydrogen-containing compound, which is capable of forming a hydrophilic group.

A detailed description is given in the following embodiments with reference to the accompanying drawings.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides an flame-retardant waterborne PU dispersion, which comprises: 1 to 50 parts by weight, preferably 5 to 30 parts by weight, more preferably 7 to 20 parts by weight of a phosphorous flame retardant containing active hydrogen; 10 to 40 parts by weight, preferably 13 to 35 parts by weight, more preferably 15 to 30 parts by weight of a diisocyanate; 30 to 80 parts by weight, preferably 40 to 75 parts by weight, more preferably 50 to 70 parts by weight of a polyol; and 1 to 15 parts by weight, preferably 3 to 10 parts by weight, more preferably 4 to 7 parts by weight of an active hydrogen-containing compound, which is capable of forming a hydrophilic group. The above mentioned “active hydrogen” means that the hydrogen atom of the compound is unstable, thus it may easily react with other compounds through chemical reactions (e.g. substitution reactions).

The phosphorous flame retardant is a polyphosphorous ester having at least three ester groups. The polyphosphate ester is represented by the following formula:

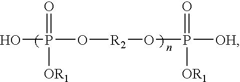

wherein R₁ is alkyl or alkoxy, preferably C1 to C4 alkyl or alkoxy, more preferably C1 to C2 alkyl or alkoxy, R2 is vinyl, and n is an integer of 50 to 270, preferably 80 to 240, more preferably 100 to 200.

Note that the phosphorous flame retardant of the invention is environmentally friendly because it generates nontoxic gas and minimal amounts of smoke when under high flammable temperatures, unlike conventional halogen flame retardants.

The active hydrogen in the phosphorous flame retardant reacts with the diisocyanate, so that the final product, polyurethane, is chemically bonded to the phosphorous flame retardant. Compared with the conventional method (by integrating), simply washing the PU of the invention with water will not reduce flame retardant effects. Thus, less flame retardants may be applied to products for the same flame-retarded effect as conventional methods, reducing overall costs.

The diisocyanate of the invention comprises aromatic diisocyanate or aliphatic diisocyanate, such as toluene diisocyanate (TDI), p-phenylene diisocyanate (PPDI), 4,4′-diphenylmethane diisocyanate (MDI), p,p′-bisphenyl diisocyanate (BPDI), isophorone diisocyanate (IPDI), 1,6-hexamethylene diisocynate (HDI), or hydrogenate diphenylmethane-4,4′-diisocyanate (H₁₂MDI). Additionally, the diisocyanate further comprises: a substituent of halo, nitro, cyano, alkyl, alkoxy, haloalkyl, hydroxyl, carboxy, amido, amino, or combinations thereof.

The polyol of the invention comprises diol, polyol containing at least three alcohol groups, or diol ether. The polyol has an average molecular weight of about 60 to 6000. The diol comprises glycol, propanediol, butanediol, pentanediol, hexanediol, cyclohexanediol, cyclohexyldimethanol (CHDM), octanediol, neopentyl glycol (NPG), trimethylpentanediol (TMPD), benzenedimethanol, benzenediol, methyl benzenediol, bisphenol-A, poly(butanediol-co-adipate) glycol (PBA), polytetramethylene glycol (PTMEG), poly(hexanediol-co-adipate) glycol (PHA), poly(ethanediol-co-adipate) glycol (PEA), polypropylene glycol (PPG), or polyethylene glycol (PEG). The polyol containing at least three alcohol groups comprises polyester polyol, polyether polyol, polycarbonate polyol, polycaprolactone polyol, or polyacrylate polyol, such as diglycol, triglycol, diprotanediol or triprotanediol. The main function of the polyol is to react with the diisocyanate to form a PU polymer. Additionally, the polyol is also applied as a physical conditioner, wherein the hardness of the PU is dependent on the molecular weight (Mw) of the polyol. In general, the lower the molecular weight of the polyol is, the lower the hardness of the PU.

Meanwhile, the function of the active hydrogen-containing compound of the invention is for the PU to efficiently disperse in water. The hydrophilic group comprises —COO⁻, —SO₃⁻, —NR₄⁺, or —(CH₂CH₂O)—. The active hydrogen-containing compound comprises dimethylol propionic acid (DMPA), dimethylol butanoic acid (DMBA), poly(ethylene oxide) glycol, bis(hydroxylethyl) amine, or sodium 3-bis(hydroxyethyl)aminopropanesulfonate.

A pre-polymer is synthesized by a prepolymer mixing process to mix the phosphorous flame retardant containing active hydrogen, the diisocyanate, the polyol and the active hydrogen-containing compound. Then, a chain extender is added into the prepolymer to increase the molecular weight of the polymer and further improve the physical properties of the polymer, such as strength or extension.

The chain extender of the invention comprises diamine, triamine, or tetraamine, such as ethylenediamine, diethylene triamine (DETA), triethylene tetraamine (TETA), 2-methyl-1,5-pentamethylene diamine, or the structure of H₂N —(CH₂)ₘ—NH₂, wherein m is an integer of 0 to 12.

Additionally, according to application, the flame retardant waterborne polyurethane dispersion of the invention further comprises a crosslinker, a thicker, or a non-phosphorus flame retardant, etc. to improve the physical properties of the dispersion.

The flame retardant waterborne polyurethane dispersion of the invention is fabricated by a prepolymer mixing process, and the preparation process as follows:

(a) 1 to 50 by weight of the phosphorous flame retardant containing active hydrogen, 30 to 80 by weight of the polyol, 1 to 15 by weight of active hydrogen-containing compound and solvent (e.g. acetone or N-methylpyrrolidone) were added into a stirring container under N₂ atmosphere.

(b) When the mixture was well mixed to present a single phase, 10 to 40 by weight of diisocyanate was added into the container, then the container was heated to about 40° C.-90° C. for 4-6 hours.

(c) When the container was cooled to 30° C.-50° C., a base solution, such as triethylamine, was added into the stirring container to neutralize the mixture for 15-20 minutes.

(d) The mixture was added into water, and then 0.1 to 5 by weight of a chain extender was added into the water to obtain the flame-retardant waterborne polyurethane dispersion of the invention.

Furthermore, The dispersion was naturally cooled down to room temperature and then dried in the oven of 80° C.-100° C. to obtain the flame retardant waterborne polyurethane dispersion in the form of a dry film.

Three main advantages of the environmentally friendly adhesive of the invention over the conventional PU is as follows:

(1) Because the phosphorous flame retardant containing active hydrogen is chemically bonded to polyurethane, the amount of the phosphorous flame retardant in the invention is not reduced by washing. Therefore, decreased amounts of the phosphorous flame retardant may be used for similar effects as conventional PU, decreasing overall costs.

(2) Because the dispersion of the invention results in easy formation of a dry film, additives, plasticizers or crosslinkers are not required. Thus, processing time and costs are reduced.

(3) The dry film of the invention pass UL 94 (Underwriters Laboratory) classification VO flammability testing with less costs. Thus, commercial applications are increased.

### EXAMPLE

### Example 1

10.36 g of dimethylol butionic acid (DMBA), 20 g of flame retardant with the following formula:

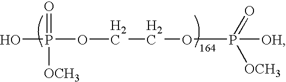

147.13 g of polytetramethylene-ether-glycol (PTMEG), 13.01 g of acetone and 14.53 g of N-methyl pyrrolidone (NMP) were added into a stirring container. When the mixture was well mixed to present a single phase, 42.51 g of 80:20 ratio of 2,4-toluene diisocyanate and 2,6-toluene diisocyanate was added into the container, then the container was heated to 55° C. for 5 hours. When the container was cooled to 50° C., 7.07 g of triethylamine (TEA) was added into the stirring container to neutralize the mixture for 20 minutes. 180 g of the mixture was quickly added into 442.78 g of water with a stirring rate 2000 rpm, then 1.69 g of ethylene diamine (EDA) was added into the water at room temperature for 2 hours to obtain the flame retardant waterborne polyurethane dispersion.

The dispersion was poured in a dish at room temperature and then dried in the oven of 100° C. for 12 hours to obtain a dry film with a thickness of about 0.4±0.2 mm. The dry film was measured by UL 94 flammability testing standards as shown in Table 1.

TABLE 1

| sample | Test Type | UL 94 classification |
|---|---|---|
| dry film | before immersing in water | V0 |
| of Example 1 | immersing in water for 3 days | V0 |
| | immersing in laundry detergent | V0 |
| | solution for 3 days | |

### Example 2

10.95 g of dimethylol butionic acid (DMBA), 20 g of flame retardant with the following formula:

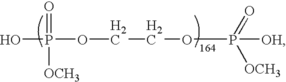

117.36 g of polytetramethylene-ether-glycol (PTMEG), 29.34 g pf polypropylene glycol (PPG), 13.76 g of acetone and 13.83 g of N-methylpyrrolidone (NMP) were added into a stirring container. When the mixture was well mixed to present a single phase, 42.34 g of 80:20 ratio of 2,4-toluene diisocyanate and 2,6-toluene diisocyanate was added into the container, then the container was heated to 55° C. for 5 hours. When the container was cooled to 50° C., 7.47 g of triethylamine (TEA) was added into the stirring container to neutralize the mixture for 20 minutes. 180 g of the mixture was quickly added into 338.16 g of water with a stirring rate 2000 rpm, then 1.61 g of ethylene diamine (EDA) was added into the water at room temperature for 2 hours to obtain the flame-retardant waterborne polyurethane dispersion.

The dispersion was poured in a dish at room temperature and then dried in the oven of 100° C. for 12 hours to obtain a dry film with a thickness of about 0.4±0.2 mm. The dry film was measured by UL 94 flammability testing standards as shown in Table 2.

TABLE 2

| sample | Test Type | UL 94 classification |
|---|---|---|
| dry film | before immersing in water | V0 |
| of Example 2 | immersing in water for 3 days | V0 |
| | immersing in laundry detergent | V0 |
| | solution for 3 days | |

From the above results, it was shown that the flame retardant waterborne polyurethane dispersion maintained flame retardant effects after immersion in water or laundry detergent for 3 days, achieving the highest class VO of the UL 94 flammability testing standards.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flame-retardant waterborne polyurethane dispersion, comprising:
1 to 50 parts by weight of a phosphorus flame retardant containing active hydrogen;
10 to 40 parts by weight of a diisocyanate;
30 to 80 parts by weight of a polyol; and
1 to 15 parts by weight of an active hydrogen-containing compound, which is capable of forming a hydrophilic group.

2. The flame-retardant waterborne polyurethane dispersion as claimed in claim 1, further comprising 0.1 to 5 parts by weight of a chain extender.

3. The flame-retardant waterborne polyurethane dispersion as claimed in claim 1, wherein the phosphorus flame retardant containing active hydrogen is a poly phosphate ester having at least three phosphate ester groups.

4. The flame-retardant waterborne polyurethane dispersion as claimed in claim 3, wherein the polyphosphate ester is represented by the following formula: 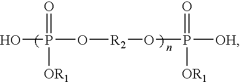
wherein R₁ is alkyl or alkoxy, R2 is vinyl, and n is an integer of 50 to 270.

5. The flame-retardant waterborne polyurethane dispersion as claimed in claim 4, wherein R₁ is C1 to C4 alkyl or alkoxy.

6. The flame-retardant waterborne polyurethane dispersion as claimed in claim 4, wherein R₁ is C1 to C2 alkyl or alkoxy.

7. The flame-retardant waterborne polyurethane dispersion as claimed in claim 4, wherein n is an integer of 80 to 240.

8. The flame-retardant waterborne polyurethane dispersion as claimed in claim 4, wherein n is an integer of 100 to 200.

9. The flame-retardant waterborne polyurethane dispersion as claimed in claim 1, wherein the diisocyanate comprises aromatic diisocyanate or aliphatic diisocyanate.

10. The flame-retardant waterborne polyurethane dispersion as claimed in claim 9, wherein the diisocyanate comprises toluene diisocyanate (TDI), p-phenylene diisocyanate (PPDI), 4,4′-diphenylmethane diisocyanate (MDI), p,p′-bisphenyl diisocyanate (BPDI), isophorone diisocyanate (IPDI), 1,6-hexamethylene diisocynate (HDI), or hydrogenate diphenylmethane-4,4′-diisocyanate (H₁₂MDI).

11. The flame-retardant waterborne polyurethane dispersion as claimed in claim 1, wherein the diisocyanate further comprises: a substituent of halo, nitro, cyano, alkyl, alkoxy, haloalkyl, hydroxy, carboxy, amido, amino, or combinations thereof.

12. The flame-retardant waterborne polyurethane dispersion as claimed in claim 1, wherein the polyol comprises diol, polyol containing at least three alcohol groups, or diol ether.

13. The flame-retardant waterborne polyurethane dispersion as claimed in claim 12, wherein the diol comprises glycol, propanediol, butanediol, pentanediol, hexanediol, cyclohexanediol, cyclohexyldimethanol (CHDM), octanediol, neopentyl glycol (NPG), trimethylpentanediol (TMPD), benzenedimethanol, benzenediol, methyl benzenediol, bisphenol-A, poly(butanediol-co-adipate) glycol (PBA), polytetramethylene glycol (PTMEG), poly(hexanediol-co-adipate) glycol (PHA), poly(ethanediol-co-adipate) glycol (PEA), polypropylene glycol (PPG), or polyethylene glycol (PEG).

14. The flame-retardant waterborne polyurethane dispersion as claimed in claim 12, wherein the polyol containing at least three alcohol groups comprises polyester polyol, polyether polyol, polycarbonate polyol, polycaprolactone polyol, or polyacrylate polyol.

15. The flame-retardant waterborne polyurethane dispersion as claimed in claim 14, wherein the polyol containing at least three alcohol groups comprises glycerol, thrmethylolpropane, pentaerythritol or benzenetriol.

16. The flame-retardant waterborne polyurethane dispersion as claimed in claim 12, wherein the diol ether comprises diglycol, triglycol, diprotanediol or triprotanediol.

17. The flame-retardant waterborne polyurethane dispersion as claimed in claim 1, wherein the polyol has an average molecular weight of about 60 to 6000.

18. The flame-retardant waterborne polyurethane dispersion as claimed in claim 1, wherein the hydrophilic group comprises —COO⁻, —SO₃⁻, —NR₄⁺, or —(CH₂CH₂O)—.

19. The flame-retardant waterborne polyurethane dispersion as claimed in claim 1, wherein the active hydrogen-containing compound comprises dimethylol propionic acid (DMPA), dimethylol butanoic acid (DMBA), poly(ethylene oxide) glycol, bis(hydroxylethyl) amine, or sodium 3-bis(hydroxyethyl)aminopropanesulfonate.

20. The flame-retardant waterborne polyurethane dispersion as claimed in claim 1, wherein the chain extender comprises diamine, triamine, or tetraamine.

21. The flame-retardant waterborne polyurethane dispersion as claimed in claim 1, wherein the chain extender comprises ethylenediamine, diethylene triamine (DETA), triethylene tetraamine (TETA), 2-methyl-1,5-pentamethylene diamine, or the structure of H₂N —(CH₂)ₘ—NH₂, wherein m is an integer of 0 to 12.

22. The flame-retardant waterborne polyurethane dispersion as claimed in claim 1, wherein the flame-retardant waterborne polyurethane dispersion further comprises a crosslinker, a thicker, or a non-phosphorus flame retardant.
